(19) United States
(12) Patent Application Publication
(10) Pub. No.: US 2021/0223210 A1
(43) Pub. Date: Jul. 22, 2021

(54) ULTRASONIC TESTING INSPECTION WITH COUPLING VALIDATION

(71) Applicant: GE Oil & Gas, LLC, Houston, TX (US)

(72) Inventors: Daniel WERNER, Hurth (DE); Frank HENRIX, Hurth (DE); Andreas FRANZEN, Hurth (DE); Stephan FALTER, Hurth (DE)

(21) Appl. No.: 16/755,291

(22) PCT Filed: Oct. 12, 2018
(86) PCT No.: PCT/US2018/055639

§ 371 Date: Apr. 10, 2020

Related U.S. Application Data
(60) Provisional application No. 62/571,448, filed on Oct. 12, 2017.

(51) Int. Cl. G01N 29/07; G01N 29/34; G01N 29/04

(52) U.S. Cl. CPC G01N 29/07; G01N 29/043; G01N 29/341

(57) ABSTRACT

An ultrasonic testing system includes one or more matrix array ultrasonic probes, a probe positioning assembly, and an analyzer. The assembly is configured to position the probes for ultrasonic communication with a target, such as a wheel, including at least one coupling validation geometry. Each of the probes is configured to emit a validation ultrasonic signal directed towards a coupling validation geometry within the wheel, measure its emitted validation ultrasonic signal after reflection from a respective coupling validation geometry, and at least one of emit an ultrasonic inspection signal and measure an inspection ultrasonic signal reflected from a defect positioned within an inspection area of the wheel. The analyzer is configured to receive the measured validation ultrasonic signal and the measured inspection ultrasonic signal, determine that the measured validation ultrasonic signal matches a reference validation signal, and output a first notification representing validation of the measured inspection ultrasonic signal.

### CROSS-REFERENCE TO RELATED APPLICATIONS

This application claims the benefit of U.S, Provisional Patent Application No. 62/571,448, filed on Oct. 12, 2017, titled “Ultrasonic Testing Inspection with Coupling Validation,” the entirety of which is hereby incorporated by reference.

### BACKGROUND

Non-destructive testing (NDT) is a class of analytical techniques that can be used to inspect a target, without causing damage, to ensure that the inspected target meets required specifications. For this reason, NDT has found wide acceptance in industries such as aerospace, power generation, oil and gas transport or refining, and transportation, that employ structures that are not easily removed from their surroundings.

As an example, global railroad standards can require train wheels to be ultrasonically inspected after manufacture and during maintenance on a regular basis. In ultrasonic testing, acoustic (sound) enemy in the form of waves can he directed. towards the train wheel. As the ultrasonic waves contact and penetrate the train wheel, they can reflect from features such as outer surfaces and interior defects (e.g., cracks, porosity, etc.). An ultrasonic sensor can acquire ultrasonic measurements of acoustic strength as a function of time. Subsequently, these ultrasonic measurements can he analyzed to provide testing. results that characterize defects present within a train wheel, such as their presence or absence, location, and/or size.

### SUMMARY

The accuracy of ultrasonic measurements can rely upon good coupling between the inspection ultrasonic probes and a target, such as a wheel. Coupling refers to the ability of ultrasonic beams to be reliably transmitted between the ultrasonic probes and the target. That is, there is substantially no impediment for ultrasonic beams to travel between the ultrasonic probes and the target. However, bad coupling can occur when the ultrasonic probe is in poor contact with the target. In one aspect, poor contact can occur due to gaps between the ultrasonic probes and the target arising from misalignment. In another aspect, poor contact can occur due to the presence of contaminants between the inspection ultrasonic probes and the target. In some instances, the target can be a wheel, such as a train wheel.

It can be desirable to validate ultrasonic testing results to ensure their accuracy. Absent validation, ultrasonic testing results can be misinterpreted, resulting in false conclusions that defects are absent or within acceptable limits. Such errors can lead to failure of wheels during operation, with catastrophic consequences such as equipment damage and human injury.

Accordingly, there exists an ongoing need for improved systems and methods for validating ultrasonic testing results.

In an embodiment, an ultrasonic testing system is provided and can include one or more matrix array ultrasonic probes, a probe positioning assembly, and an analyzer. The probe positioning assembly can be configured to mechanically couple to the one or more matrix array ultrasonic probes and to position the one or more matrix array ultrasonic probes for ultrasonic communication with a wheel including at least one coupling validation geometry. Each of the one or more matrix array ultrasonic probes can be configured to emit a validation ultrasonic signal directed towards a coupling validation geometry within the wheel, to measure its emitted validation ultrasonic signal after reflection from a respective one of the at least one coupling validation geometry, and to at least one of, emit an ultrasonic inspection signal and measure an inspection ultrasonic signal reflected from a defect positioned within an inspection area of the wheel. The analyzer can he configured to, receive the measured validation ultrasonic signal and the measured inspection ultrasonic signal, determine that the measured validation ultrasonic signal matches a reference validation signal, and output a first notification representing validation of the measured inspection ultrasonic signal,

In another embodiment, the analyzer can be configured to determine that the measured validation ultrasonic signal does not match the reference validation signal, and to output a second notification representing invalidation of the measured inspection ultrasonic signal.

In another embodiment, each of the matrix array ultrasonic probes can be configured to sweep the emitted validation ultrasonic beam through an arc of predetermined directions and to measure a plurality of validation ultrasonic signals after reflection from a plurality of respective coupling validation geometries.

In another embodiment, each of the matrix array ultrasonic probes emitting the inspection ultrasonic signal can be configured to sweep the inspection ultrasonic signal through an arc of predetermined directions and each of the matrix array ultrasonic probes measuring the reflected inspection ultrasonic beam can be configured to measure a plurality of inspection ultrasonic signals after reflection from a plurality of respective defects.

Embodiments of the matrix ultrasonic probes can adopt a variety of configurations. In one aspect, the system includes at least two matrix ultrasonic probes and the probe holder can be configured to position the at least two matrix array ultrasonic probes with respect to one another in a configuration mimicking a curvature of a running tread of the wheel. In another aspect, a first one of the at least two matrix ultrasonic probes can be configured to emit the inspection ultrasonic signal towards the inspection area, and a second one of the at least two matrix array ultrasonic probes can be configured to measure the inspection ultrasonic signal reflected from a defect within the inspection area. In a further aspect, a first one of the at least two matrix ultrasonic probes and a second one of the at least two ultrasonic probes can each be configured to emit the inspection ultrasonic signal towards the inspection area and to measure the inspection ultrasonic signal reflected from a defect within the inspection area.

In another embodiment, the probe positioning assembly can be configured to reversibly lift the wheel above an underlying surface and to rotate the wheel while lifted.

In another embodiment, the system can include an annunciator in communication with the analyzer. The annunciator can be configured to annunciate a first annunciation representing validation of the inspection ultrasonic signal in response to receipt of the first notification. The annunciator can also be configured to annunciate a second annunciation, different from the first annunciation, representing invalidation of the inspection ultrasonic signal in response to receipt of the second notification.

In an embodiment, a method for ultrasonic inspection is provided. The method can include positioning one or more matrix array ultrasonic probes for ultrasonic communication with a wheel including at least one coupling validation geometry. The method can also include emitting, by each of the one or more matrix array ultrasonic probes, a validation ultrasonic signal directed towards a coupling validation geometry within the wheel. The method can further include measuring, by each of the one or more matrix array ultrasonic probes, its emitted validation ultrasonic signal after reflection from a respective one of the at least one coupling validation geometry. The method can additionally include emitting, by at least one of the matrix ultrasonic probes, an ultrasonic inspection signal towards an inspection area of the wheel. The method can also include measuring, by at least one of the matrix ultrasonic probes, the inspection ultrasonic signal after reflection from a defect positioned within the inspection area. The method can additionally include receiving, by an analyzer in communication with each of the one or more matrix array ultrasonic probes, the measured validation ultrasonic signal and the measured inspection ultrasonic signal. The method can also include determining, by the analyzer, that the measured validation ultrasonic signal matches a reference validation signal. The method can additionally include outputting, by the analyzer, a first notification representing validation of the measured inspection ultrasonic signal.

In another embodiment, the method can include, determining, by the analyzer, that the measured validation ultrasonic signal does not match the reference validation signal, and outputting, by the analyzer, a second notification representing invalidation of the measured inspection ultrasonic signal.

In another embodiment, each of the matrix array ultrasonic probes can be configured to sweep the emitted validation ultrasonic beam through an arc of predetermined directions, and to measure a plurality of validation ultrasonic signals after reflection from a plurality of respective coupling validation geometries.

In another embodiment, each of the matrix array ultrasonic probes emitting the inspection ultrasonic signal can be configured to sweep the inspection ultrasonic signal through an arc of predetermined directions, and each of the matrix array ultrasonic probes measuring the reflected inspection ultrasonic beam can be configured to measure a plurality of inspection ultrasonic signals after reflection from a plurality of respective defects within the inspection area.

In another embodiment, the at least one matrix array ultrasonic probe can adopt a variety of configurations. In one aspect, the at least one matrix array ultrasonic probe can include at least two matrix ultrasonic probes. The at least two matrix array ultrasonic probes can be positioned with respect to one another in a configuration mimicking a curvature of a running tread of the wheel. In another aspect, a first one of the at least two matrix ultrasonic probes can he configured to emit the inspection ultrasonic signal towards the inspection area, and a second one of the at least two matrix array ultrasonic probes can be configured to measure the inspection ultrasonic signal reflected from a defect within the inspection area. In another aspect, a first one of the at least two matrix array ultrasonic probes and a second one of the at least two ultrasonic probes can each be configured to emit the inspection ultrasonic signal towards the inspection area and to measure the inspection ultrasonic signal reflected from a defect within the inspection area.

In another embodiment the one or more matrix array ultrasonic probes can be positioned with respect to the wheel while the wheel is lifted above an underlying surface.

In another embodiment, the method can further include rotating the wheel while lifted and after each matrix array ultrasonic probe measures its emitted validation ultrasonic signal and emits and/or measures its inspection ultrasonic signal.

In another embodiment, the wheel is a train wheel.

### BRIEF DESCRIPTION OF DRAWINGS

These and other features will be more readily understood from the following detailed description taken in conjunction with the accompanying drawings, in which:

FIG. 1 is an image illustrating a train and a train wheel;

FIG. 2A is an image illustrating one exemplary embodiment of an operating environment including a ultrasonic testing system having a ultrasonic probe for inspection of train wheels;

FIG. 2B is a schematic diagram illustrating a zoomed-in view of the ultrasonic testing system of FIG. 2A;

FIG. 3A is a side view of a portion of a train wheel illustrating ultrasonic probes of an existing ultrasonic testing system positioned thereon for ultrasonic testing;

FIG. 3B is a cross-sectional front view of FIG. 3A;

FIG. 4A is a diagram illustrating one exemplary embodiment of a matrix array ultrasonic probe;

FIG. 4B is a side view of a portion of a train wheel illustrating an exemplary embodiment of matrix array ultrasonic probe according to FIG. 4A positioned thereon for ultrasonic testing;

FIG.4C is a cross-sectional front view of FIG. 4B,

FIGS. 5A-5D are front cross-sectional views of other embodiments of train wheels illustrating coupling validation features and matrix array ultrasonic probes positioned thereon for ultrasonic testing;

FIG. 6 is a schematic illustration of an analysis system of the ultrasonic inspection system of FIGS. 4A-5D; and

FIG. 7 is a flow diagram illustrating an exemplary embodiment of a method for ultrasonic inspection and coupling validation using matrix array ultrasonic probes.

It is noted that the drawings are not necessarily to scale. The drawings are intended to depict only typical aspects of the subject matter disclosed herein, and therefore should not be considered as limiting the scope of the disclosure. Those skilled in the art will understand that the systems, devices, and methods specifically described herein and illustrated in the accompanying drawings are non-limiting exemplary embodiments and that the scope of the present invention is defined solely by the claims.

### DETAILED DESCRIPTION

Wheels, for example train wheels, can develop damage, such as cracks, over time during use. If this damage becomes too severe, it can cause the wheel to break. To avoid failure of wheels during service, they can be inspected periodically. In some cases, because damage is not visible on the surface of the wheel, inspection can include techniques that allow the interior of the wheel to be investigated, such as ultrasonic testing. In ultrasonic testing, ultrasonic probes can he positioned on the wheel and they can send and receive ultrasonic waves (high frequency sound waves) to detect defects beneath the surface of the wheel. When ultrasonic testing is performed correctly, ultrasonic waves can easily travel between the ultrasonic probes and the wheel. This condition, referred to as coupling, and can ensure that defects are accurately measured. Existing ultrasonic testing systems can use one or more first ultrasonic probes to measure defects and one or more second ultrasonic probes, different from the first ultrasonic probes, to make measurements that validate the ultrasonic coupling of the first ultrasonic probes. However, this technique assumes that coupling validation measurements acquired by the second probe(s) are applicable to the first ultrasonic probe(s). However, in sonic cases, this assumption can be false, and the defect measurements acquired by the first set of ultrasonic probes can be erroneous due to poor coupling. Accordingly, improved ultrasonic testing systems and corresponding methods are provided in which each ultrasonic probe is configured to measure defects within a target, such as a wheel, and to validate its coupling to the wheel. Because each ultrasonic probe can independently validate its coupling to the wheel, as long as its coupling remains validated, its defect measurements are ensured to be accurate.

Embodiments of ultrasonic testing systems and corresponding methods for validating ultrasonic measurements acquired for train wheels are discussed herein. However, embodiments of the disclosure can be employed for ultrasonic testing of other target objects without limit.

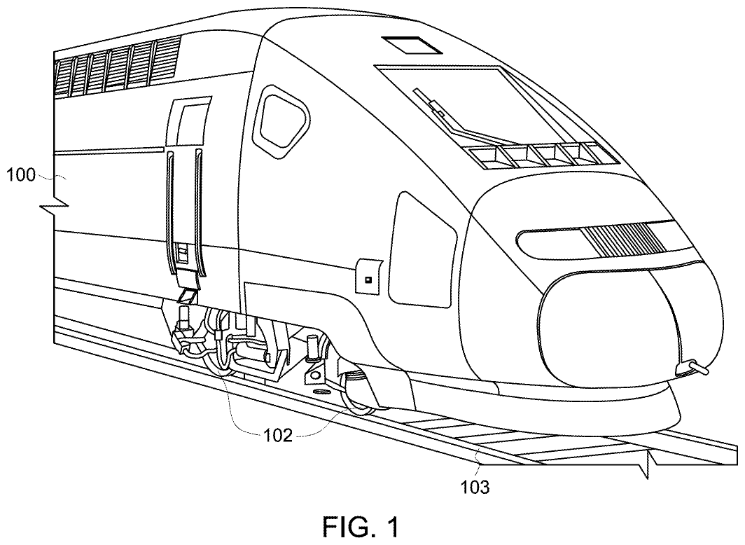

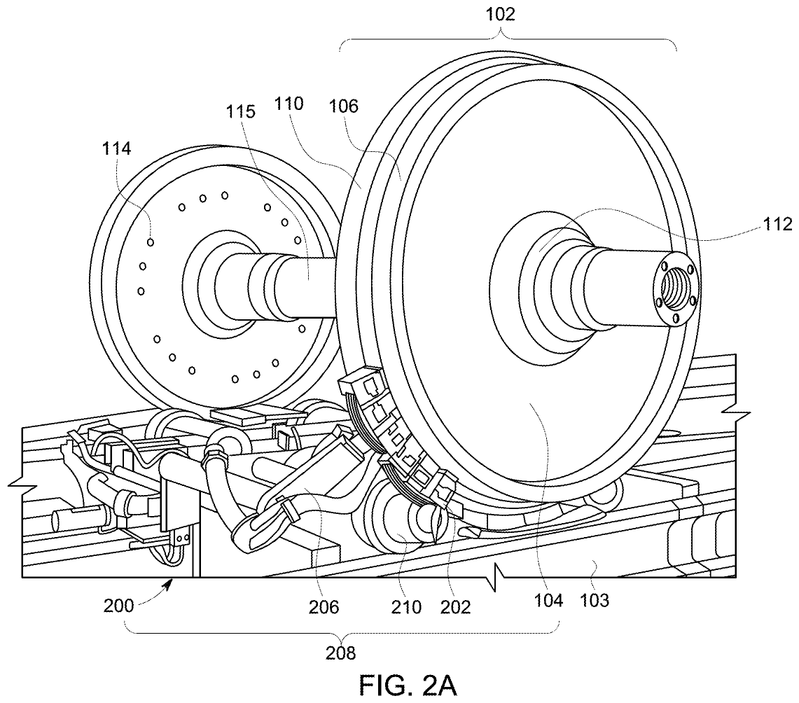

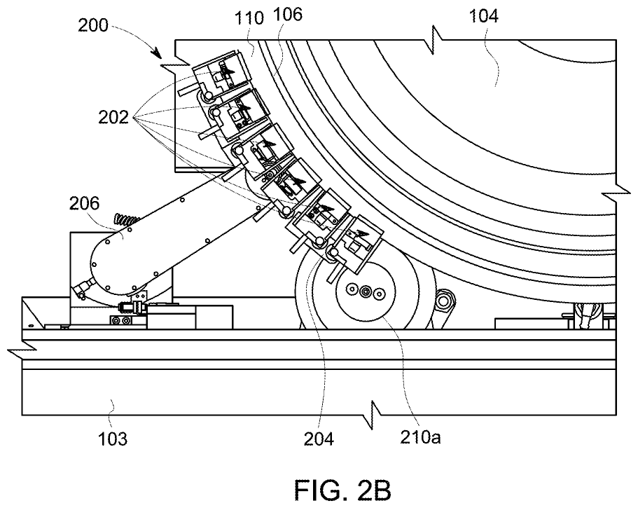

FIG. 1 illustrates an embodiment of a train 100 including train wheels 102 positioned on rails 103, and FIGS. 2A-2B illustrate one exemplary embodiment of an ultrasonic testing system 200 for inspection of a train wheel 102. As shown, the train wheel 102 can include a wheel disk 104, a running tread 106, and a wheel flange 110. The wheel disk 104 can form a center of the train wheel 102 and the running tread 106 can form a circumferential outer surface of the train wheel 102. The wheel flange 110 can be formed on one side of the train wheel 102 (e.g., an interior side) and extend radially outward from the running tread 106.

The wheel disk 104 can include one or more holes therethrough. As shown, a primary hole 112 can he positioned at about a center of the wheel disk 104 and be configured for receipt of an axle 115 therethrough, One or more secondary holes 114 can be formed radially outward from the primary hole 112 and configured for coupling other components to the train wheel 102, such as brake disks (not shown).

The ultrasonic testing system 200 can include one or more ultrasonic probes 202 and a probe positioning assembly 208 including a probe holder 204, a probe holder mount 206, and a lift and rotation unit 210. As shown, a predetermined number of ultrasonic probes 202 can be mechanically coupled to the probe holder 204 and oriented with respect to one another by the probe holder 204 (e.g., in an arcuate configuration mimicking a curvature of the running tread 106). Each probe holder 204 in turn can be coupled to the probe holder mount 206, When using the ultrasonic testing system 200 for inspection of train wheel 102, the lift and rotation unit 210 can he configured to lift the train wheel 102 above the underlying rail 103 and rotate the train wheel 102 about an axis extending through the primary hole 112 (e.g., via one or more rotation wheels 210a). The probe holder mount 206 can be coupled to the probe holder 204 and it can be configured to position the ultrasonic probes 202 adjacent to or in contact with the running tread 106 for ultrasonic communication with the train wheel 102 while lifted. While not shown, an ultrasonic couplant fluid can be provided between the ultrasonic probes 202 and the train wheel 102 to facilitate ultrasonic communication.

In general, when ultrasonic beams pass through a material, they can reflect from surfaces of the material, such as interior defects (e.g., cracks, pores, etc.) and outer surfaces. Material features, such as geometric boundaries and defects, can reflect ultrasonic beams in different ways. Some material features can reflect ultrasonic beams better than others, and the strength of the reflected ultrasonic beams can vary. Material features can also be at different distances from the ultrasonic probes and the time at which reflected ultrasonic beams reach the ultrasonic probes can vary. Measurements of the strength and time behavior of ultrasonic beams reflected from the train wheel 102 can be analyzed to determine the position and size of internal defects.

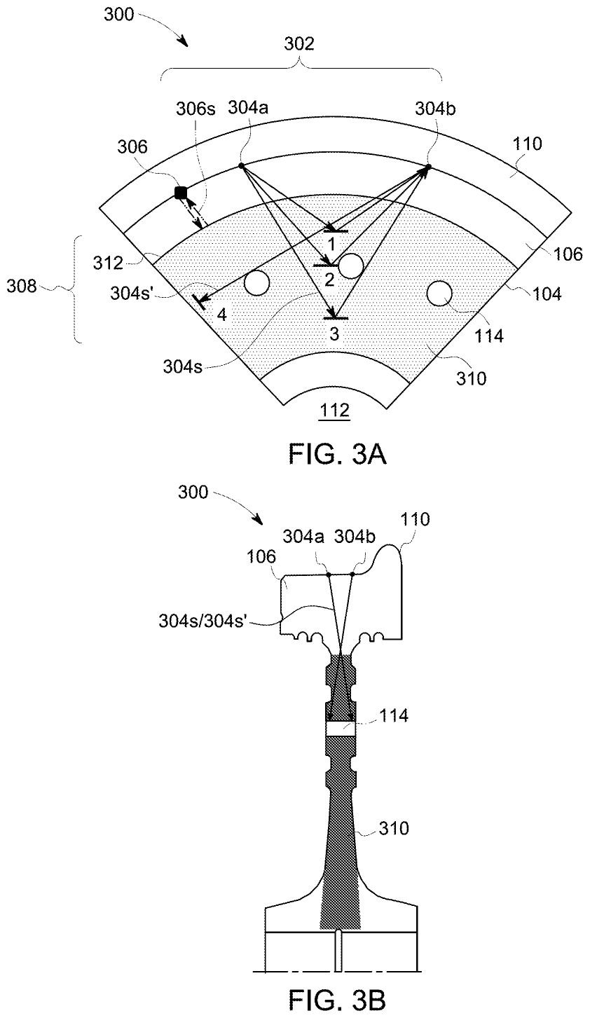

FIG. 3A is a side view of a portion of the train wheel 102, illustrating ultrasonic testing system 200 in the form of ultrasonic testing system 300 which includes two sets of ultrasonic probes 302 for ultrasonic testing according to an existing technique. As shown, the ultrasonic probes 302 are positioned on the train wheel 102 (e.g., an outer circumferential surface of the running tread 106) and they can include one or more inspection ultrasonic probes (e.g., 304a, 304b) and a validation ultrasonic probe (e.g., 306), A corresponding cross-sectional front view of the train wheel 102 is illustrated in FIG. 3B. The ultrasonic testing system 300 can also include the probe holder 204, the probe holder mount 206, and a lift and rotation unit 210, which are omitted for clarity.

Each of the ultrasonic probes 302a, 302b can include a single ultrasonic active element configured to generate and/or measure ultrasonic waves (also referred to as ultrasonic beams) for ultrasonic inspection of the train wheel 102 within an inspection area 310. The inspection area 310 can be located between the primary hole 112 and the running tread 106. The inspection ultrasonic probes 304a, 304b can be configured to measure defects 308 (e.g., 1, 2, 3, 4) within the inspection area 310 by sending and receiving inspection ultrasonic signals 304s. In one aspect, the inspection ultrasonic probes 304a, 304b can be paired, one for transmitting and one for receiving, referred to as a “V-transmission configuration.” As shown in FIG. 3A, a first inspection ultrasonic probe 304a can be configured to emit an inspection ultrasonic signal 304s. If a defect 308 is present in the path of the inspection ultrasonic signal 304s, it can reflect from that defect 308 (e.g., 1, 2, 3) and be measured by a second inspection ultrasonic probe 304b. In another aspect, a single one of the inspection ultrasonic probes 304a, 304b can both generate and measure an inspection ultrasonic beam that is reflected from one of the defects 308, also referred to as direct scan. As shown, the second inspection ultrasonic probe 304b can generate an ultrasonic inspection signal 304s′ that is reflected from one of the defects 308 (e.g., 4) within the inspection area 310 and measure the reflected ultrasonic inspection signal 304s c. In either case, analysis of the measured ultrasonic inspection signals 304s, 304s′ can provide estimates of the size and location of one or more of the defects 308 (e.g., 1, 2, 3, 4) within the inspection area 310.

The validation ultrasonic probe 306 can be employed to validate the coupling of the inspection ultrasonic probes 304a, 304b. In general, wheel disk geometries can include features that reflect ultrasonic beams with defined, characteristic, and well-known reflection properties. Examples of such features can include, but are not limited to, convex radii such as an intersection radius from the running tread 106 to the wheel disk 104. These features can be referred to herein as coupling validation geometries 312. The validation ultrasonic probe 306 can be configured to generate and measure validation ultrasonic signals 306s reflected from coupling validation geometries 312. When the validation ultrasonic signals 306s measured by the validation ultrasonic probe 306 agree with an expected behavior, coupling can be considered to he good or validated. When the validation ultrasonic signals 306s measured by the validation ultrasonic probe 306 deviate from an expected behavior, coupling can be considered to be poor or not validated.

Use of the validation ultrasonic probe 306 separate from the inspection ultrasonic probe(s) 302 can be problematic for a number of reasons, however.

In one aspect, it is assumed that when the validation ultrasonic probe 306 validates its own coupling to the train wheel 102, this result is applicable to the inspection ultrasonic probes 304a, 304b as well. However, under worst case scenarios, this assumption is not true. Therefore, existing ultrasonic testing systems, such as ultrasonic testing system 300, can fail to properly validate the inspection ultrasonic probes 304a, 304b, risking incorrect interpretation of ultrasonic testing results.

In another aspect, because they are configured to generate and measure ultrasonic beams for different features within the train wheel 102 (e.g., the defects 308 as compared to coupling validation geometries 312), the orientation of the inspection ultrasonic probes 304a, 304b and the validation ultrasonic probe 306 are different. That is, respective ones of the ultrasonic probes 302 cannot both measure defects 308 and perform validation.

In a further aspect, the need for a validation ultrasonic probe 306 separate from the inspection ultrasonic probes 304a, 304b can add additional cost and complexity to existing ultrasonic testing systems (e.g., ultrasonic testing system 300).

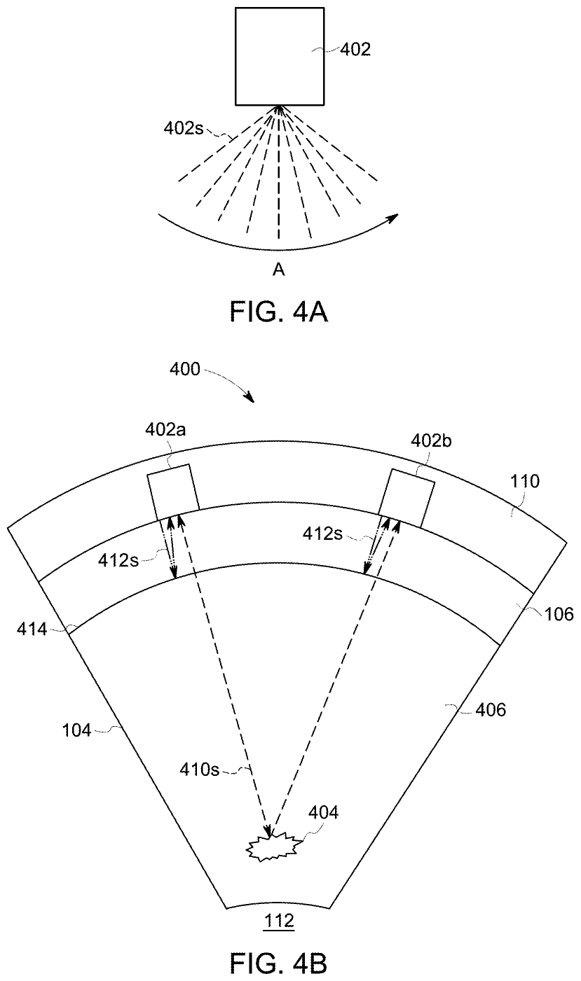

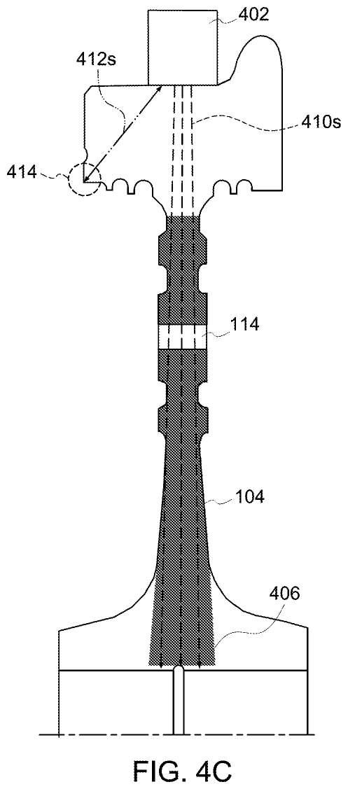

Embodiments of the present disclosure provide improved systems and methods for ultrasonic testing. An improved ultrasonic testing system 400 can be similar to the ultrasonic testing system 200, including, the probe holder 204, the probe holder mount 206, and the lift and rotation unit 210 of FIG. 2. However, the ultrasonic probes 202 are replaced with matrix array ultrasonic probes 402, also referred to as phased array ultrasonic probes, illustrated in FIG. 4A. A matrix array ultrasonic probe 402 can include two or more ultrasonic active elements. These ultrasonic active elements can be configured to generate and measure ultrasonic beams and they can be arranged in a predetermined pattern with respect to one another (e.g., a line, a circle, a grid, etc.). Each of the ultrasonic active elements can also be configured to generate ultrasonic beams that are varied in strength and/or time with respect to ultrasonic beams generated by the other ultrasonic active elements. The various ultrasonic beams can interfere with each other to produce a net ultrasonic beam 402s in a predetermined direction. This process can be repeated as necessary to sweep the ultrasonic beam 402s through an arc A of different predetermined directions. Exemplary embodiments of matrix array ultrasonic probes 402 can be found in U.S. Pat. No. 9,244,043, the entirety of which is herein incorporated by reference.

FIG. 4B is a side view of a portion of the train wheel 102. As shown, matrix array ultrasonic probes 402 can be positioned on or adjacent to the train wheel 102 (e.g., an outer circumferential surface of the running tread 106) for ultrasonic testing. A corresponding cross-sectional front view of the train wheel 102 is illustrated in FIG. 4C. Two matrix array ultrasonic probes 402a, 402b are illustrated and remaining portions of the improved ultrasonic testing system 400 are omitted for clarity. However, any number of matrix array probes can be employed without limit. Under circumstances where the system is employed with wheels other than train wheels, the matrix array ultrasonic probes can be positioned on or adjacent to the wheel at a suitable location, such as an outer circumferential surface of the wheel.

Each of the matrix array ultrasonic probes 402 can be configured to acquire measurements for detection of defects 404 within an inspection area 406 and validation their ultrasonic coupling with respect to the train wheel 102. As an example, the inspection area 406 can extend from the running tread 106 and the primary hole 112.

As shown in FIG. 4B, the matrix array ultrasonic probes 402 are arranged in a V-transmission configuration. The matrix array ultrasonic probe 402a can be configured to generate an inspection ultrasonic signal 410s that is directed towards the inspection area 406. If the defect 404 is present in the path of the inspection ultrasonic signal 410s, the inspection ultrasonic signal 410s can reflect from the defect 404 and be measured by matrix array ultrasonic probe 402b. As further shown, both of the matrix array ultrasonic probes 402a, 402b can also be configured to generate and measure a respective validation ultrasonic signal 412s reflected from a coupling validation geometry 414. Accordingly, the inspection ultrasonic signal 410s and the validation ultrasonic signal 412s can be emitted and reflected in different directions from each other. As discussed above, the coupling validation geometry 414 can be one or more features that reflect ultrasonic beams with defined, characteristic, and well-known reflection properties (e.g., features with convex radii). While V-transmission configurations have been discussed above, embodiments of the improved ultrasonic testing system can also employ matrix ultrasonic probes in a direct scan configuration, where each matrix ultrasonic probe both generates and measures inspection ultrasonic beams after reflection from a defect.

In certain embodiments, the train wheel 102 can be lifted from an underlying surface (e.g., the rail 103) while the inspection ultrasonic signal 410s and the validation ultrasonic signal 412s are emitted and reflected. The train wheel 102 can also be rotated while lifted to facilitate inspection of the substantially the entire volume of the inspection area 406. In one aspect, rotation can be performed after measurement of reflected inspection ultrasonic signal 410s and validation ultrasonic signal 412s. In another aspect, rotation can be performed at a selected speed during emission of inspection ultrasonic signal 410s and validation ultrasonic signal 412s, reflection of reflected inspection ultrasonic signal 410s and validation ultrasonic signal 412s, and/or measurement of reflected inspection ultrasonic signal 410s and validation ultrasonic signal 412s.

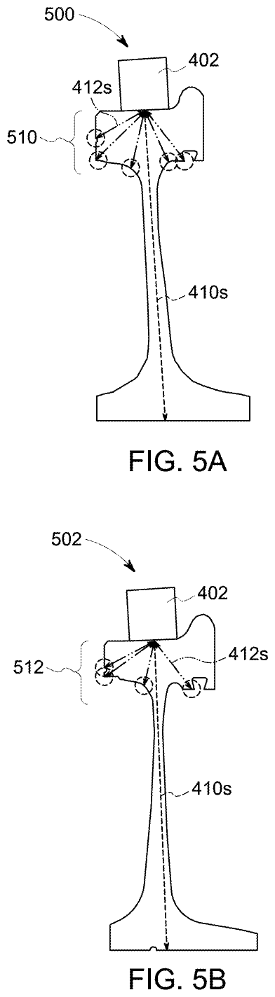

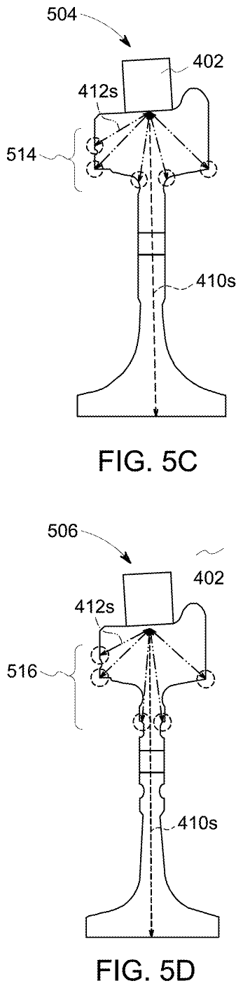

FIGS. 5A-5D illustrate front cross-sectional views of additional exemplary embodiments of train wheels 500, 502, 504, 506 having different coupling validation geometries 510, 512, 514, 516 and respective matrix array ultrasonic probes 402 positioned thereon for ultrasonic testing. The coupling validation geometries 510, 512, 514, 516 for each of the train wheels 500, 502, 504, 506 are circled for reference. As an example, coupling validation geometries 510, 512, 514, 516 can be present within the running tread 106, the wheel disk 104, or combinations thereof. As shown, embodiments of the matrix array ultrasonic probes 402 can direct validation ultrasonic signals 412s towards one or more of the coupling validation geometries 510, 512. 514, 516 of their respective train wheel 500, 502, 504, 506 in order to validate their coupling thereto. Further, as discussed above, the matrix array ultrasonic probes 402 can direct inspection ultrasonic signals 410s into the inspection area 406 for detection of defects 404.

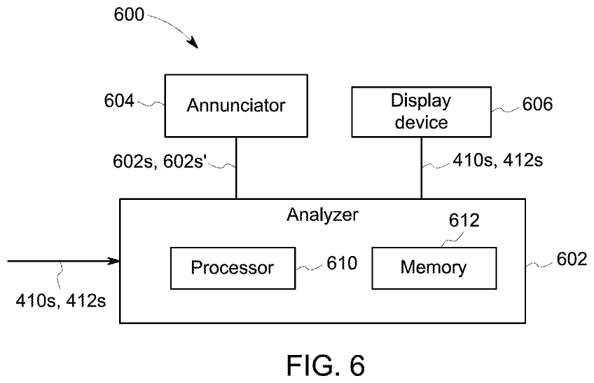

FIG. 6 illustrates an analysis system 600 of the improved ultrasonic testing system 400 configured for electronic communication with each of the matrix array ultrasonic probes 402. The analysis system 600 can include an analyzer 602, an annunciator 604, and a display device 606. The analyzer 602 can be any computing device employing a general purpose or application specific processor (e.g., processor 610) and can also include a memory 612. The processor 610 can include one or more processing devices, and the first memory 220 can include one or more tangible, non-transitory, machine-readable media collectively storing instructions executable by the first processor 216 to perform the methods and control actions described herein. Embodiments of the analyzer 602 can be implemented using analog electronic circuitry, digital electronic circuitry, and combinations thereof.

In one embodiment, the memory 612 can store a reference validation signal for each coupling validation geometry 414. The reference validation signal can represent a validation ultrasonic signal 412s measured under conditions of good coupling. The memory 612 can further store instructions and/or algorithms for determining whether the measured validation ultrasonic signal 412s reflected from a coupling validation geometry 414 matches a corresponding reference ultrasonic signal for that coupling validation geometry 414. As an example, a match can be determined when the strength of the measured validation ultrasonic signal 412s and the reference validation ultrasonic signal vary from one another by less than a predetermined threshold amount as a function of time. Conversely, a match may not be determined when the strength of the measured validation ultrasonic signal 412s and the reference validation ultrasonic signal vary from one another by greater than the predetermined threshold amount as a function of time.

In an alternative embodiment, the memory can store a reference validation signal strength for each validation coupling geometry. The reference validation signal strength can represent a threshold strength above which a validation ultrasonic signal can be considered to represent good coupling. The memory can further store instructions and/or algorithms for determining whether the measured validation ultrasonic signal reflected from a coupling validation geometry exhibits a strength greater than or equal to the reference validation signal strength for that coupling validation geometry. A measured validation ultrasonic signal having a strength greater than or equal to the reference validation signal strength can be considered to possess good coupling. Conversely, a measured validation ultrasonic signal determined having a strength less than the reference validation signal strength can be considered to possess poor coupling.

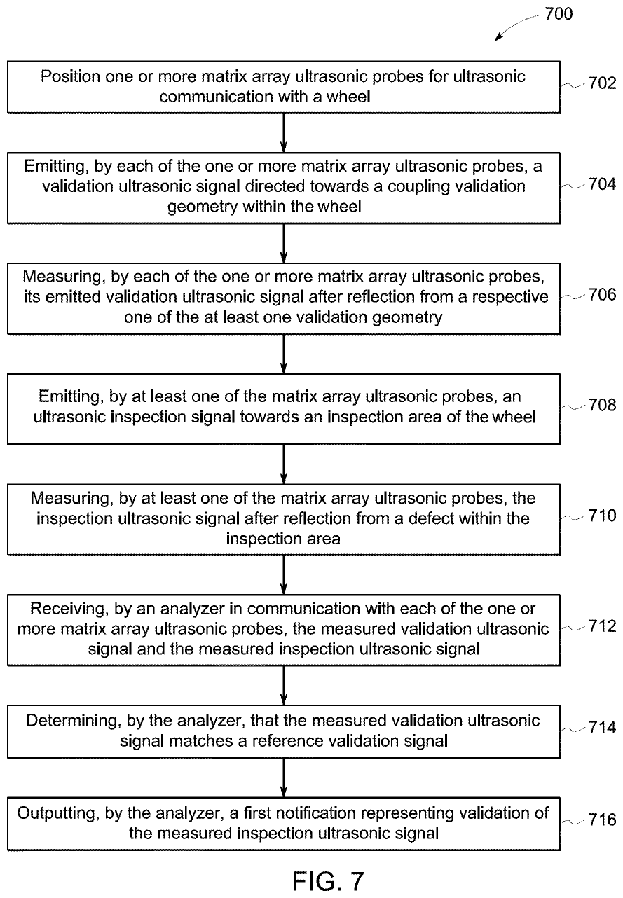

FIG. 7 is a flow diagram illustrating an exemplary embodiment of a method 700 for ultrasonic inspection in which each of the matrix array ultrasonic probes 402 can be configured to both perform ultrasonic inspection of the train wheel 102 and validate its ultrasonic coupling with the train wheel 102. The method 700 is described below in connection with the improved ultrasonic testing system 400 of FIGS. 4A-6. As illustrated, the method 700 includes operations 702-716. However, alternative embodiments of the method can include greater or fewer operations than illustrated in FIG. 7, and the operations can be performed in a different order than illustrated in FIG. 7.

In operation 702, one or more matrix array ultrasonic probes 402 can be positioned for ultrasonic communication with the train wheel 102. In an embodiment, the matrix array ultrasonic probes 402 can be positioned using the probe positioning assembly 208. As an example, the one or more matrix array ultrasonic probes 402 can be positioned on or adjacent to the running tread 106 of the train wheel 102. In further embodiments, the one or more matrix array ultrasonic probes 402 can include at least two matrix array ultrasonic probes (e.g., 402a, 402b) positioned with respect to one another in a configuration that mimics a curvature of the running tread 106. In operations 704-706, each of the one or more matrix array ultrasonic probes 402 can emit the validation ultrasonic signal 412s towards a coupling validation geometry (e.g., 414) within the train wheel 102 and measure the corresponding reflected validation ultrasonic signals 412s. As illustrated in FIGS. 5A-5D, the train wheel 102 can include one or more coupling validation geometries (e.g., 414). Furthermore, each of the matrix array ultrasonic probes 402 can be configured to sweep the emitted validation ultrasonic signal 412s through an arc of predetermined directions and measure a plurality of validation ultrasonic signals 412s after reflection from a plurality of coupling validation geometries 414.

In operation 708, each of the matrix array ultrasonic probes 402 can emit an ultrasonic inspection signal 410s towards the inspection area 406 of the train wheel 102. Similar to the validation ultrasonic signals 412s, the emitted inspection ultrasonic signals 410s can be swept through an arc of predetermined directions. In operation 710, at least one of the matrix array ultrasonic probes 402 can measure the emitted inspection ultrasonic signal 410s after reflection from a defect within the inspection area 406 (e.g., defect 404). Thus, each of the matrix array ultrasonic probes 402 that emits an inspection ultrasonic signal 410s can be configured to sweep the inspection ultrasonic signal 410s through an arc of predetermined directions, and each of the matrix array ultrasonic probes 402 that measures the reflected inspection ultrasonic signal 410s can be configured to measure a plurality of inspection ultrasonic signals 410s after reflection from a plurality of respective defects 404.

In certain embodiments, the one or more matrix array ultrasonic probes 402 can include at least two matrix array ultrasonic probes (e.g., 402a, 402b). In one aspect, a first one of the at least two matrix array ultrasonic probes 402a can be configured to emit the inspection ultrasonic signal 410s towards the inspection area 406, and a second one of the at least two matrix array ultrasonic probes 402b can be configured to measure the inspection ultrasonic signal 410s reflected from a defect 404 (e.g., a V-transmission configuration). In another aspect, the first matrix array ultrasonic probe 402a and the second matrix array ultrasonic probe 402b can each be configured to emit the inspection ultrasonic signal 410s and to measure its inspection ultrasonic signal 410s reflected from a defect 404 (e.g., a direct beam configuration).

The manner in which the inspection ultrasonic signals 410s and validation ultrasonic signals 412s are generated can be chosen based upon the train wheel 102 under inspection. In general, a predefined number of inspection ultrasonic beams can be generated, followed by a validation ultrasonic signal, or vice versa. In one aspect, the inspection ultrasonic signals and validation ultrasonic signals can be alternatingly generated. In another aspect, a predetermined number of inspection ultrasonic signal can be generated (e.g., approximately 100,) followed by one or more validation ultrasonic signal. This cycle can be repeated or varied as necessary for the duration of ultrasonic testing.

In operations 712-716, the analyzer 602 can validate the ultrasonic coupling of the matrix array ultrasonic probes 402. In operation 712, the analyzer 602 can receive a measured validation ultrasonic signal 412s and a measured inspection ultrasonic signal 410s (e.g., from matrix array ultrasonic probes 402). In operation 714, the analyzer 602 can determine that the measured validation ultrasonic signal 412s matches a reference validation ultrasonic signal. The reference validation ultrasonic signal 412 can he maintained by the memory 612 and the processor 610 can conduct a comparison of the two to determine a match. As an example, a match can be identified when the measured validation ultrasonic signal 412s and the reference validation ultrasonic signal differ by less than a threshold amount (e.g., on the basis of strength as a function of time). Under this circumstance, the analyzer 602 can be configured to output a first notification signal 602s representing validation of the measured inspection ultrasonic signal 41.0s in operation 716. Conversely, under circumstances where the measured validation ultrasonic signal 412s and the reference validation ultrasonic signal differ by greater than or equal to the threshold amount (e.g., on the basis of strength as a function of time), the analyzer 602 can be configured to output a second notification signal 602s′ representing invalidation of the measured inspection ultrasonic signal 410s in operation 716.

The first and second notification signals 602s, 602s′ can be received by annunciator 604. The annunciator 604 can be configured to annunciate a first annunciation (e.g., audio, video, text, etc.) representing validation of the inspection ultrasonic signal 410s in response to receipt of the first notification signal 602s. The annunciator 604 can be configured to annunciate a second annunciation (e.g., audio, video, text, etc.) representing invalidation of the inspection ultrasonic signal 410s in response to receipt of the second notification signal 602s′.

Exemplary technical effects of the methods, systems, and devices described herein include, by way of non-limiting example, integrated ultrasonic testing and ultrasonic coupling validation. In one aspect, ultrasonic coupling validation can be provided for each of the matrix array ultrasonic probes. That is, unlike existing ultrasonic testing system, ultrasonic coupling between each matrix ultrasonic probe and a train wheel can be measured directly, rather than assumed based upon measurements from other ultrasonic probes. This direct validation can ensure that ultrasonic testing results are properly interpreted. In another aspect, the use of matrix array ultrasonic probes in an ultrasonic testing system can substantially minimize the risk that defects are missed due to erroneous interpretations of ultrasonic testing results. In a further aspect, improved ultrasonic testing systems can be provided in which all ultrasonic probes are employed for detection of defects. That is in contrast to existing ultrasonic testing systems where some probes (e.g., validation ultrasonic probes) are employed solely for coupling validation and not defect detection. The absence of probes configured for different functions can reduce the complexity and cost of ultrasonic testing.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented. as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files e.g., files that store one or more modules, sub-programs, or portions of code). A computer program can be deployed to he executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can he performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Certain exemplary embodiments are described to provide an overview of the principles of the structure, function, manufacture, and use of the systems, devices, and methods disclosed herein. One or more examples of these embodiments are illustrated in the accompanying drawings. The features illustrated or described in connection with one exemplary embodiment can be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not o be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described. All publications and references cited herein are expressly incorporated by reference in their entirety.

1. An ultrasonic testing system, comprising:
one or more matrix array ultrasonic probes;
a probe positioning assembly configured to mechanically couple to the one or more matrix array ultrasonic probes and to position the one or more matrix array ultrasonic probes for ultrasonic communication with a wheel including at least one coupling validation geometry;
wherein each of the one or more matrix array ultrasonic probes is configured to:
emit a validation ultrasonic signal directed towards a coupling validation geometry within the wheel;
measure its emitted validation ultrasonic signal after reflection from a respective one of the at least one coupling validation geometry; and
at least one of emit an ultrasonic inspection signal and measure an inspection ultrasonic signal reflected from a defect positioned within an inspection area of the wheel; and
an analyzer configured to:
receive the measured validation ultrasonic signal and the measured inspection ultrasonic signal;
determine that the measured validation ultrasonic signal matches a reference validation signal; and
output a first notification representing validation of the measured inspection ultrasonic signal.

2. The system of claim 1, wherein the analyzer is further configured to:
determine that the measured validation ultrasonic signal does not match the reference validation signal; and
output a second notification representing invalidation of the measured inspection ultrasonic signal.

3. The system of claim 1, wherein each of the matrix array ultrasonic probes is configured to sweep the emitted validation ultrasonic beam through an arc of predetermined directions and to measure a plurality of validation ultrasonic signals after reflection from a plurality of respective coupling validation geometries.

4. The system of claim 1, wherein each of the matrix array ultrasonic probes emitting the inspection ultrasonic signal is configured to sweep the inspection ultrasonic signal through an arc of predetermined directions and each of the matrix array ultrasonic probes measuring the reflected inspection ultrasonic beam is configured to measure a plurality of inspection ultrasonic signals after reflection from a plurality of respective defects.

5. The system of claim 1, comprising at least two matrix ultrasonic probes, wherein the probe holder positions the at least two matrix array ultrasonic probes with respect to one another in a configuration mimicking a curvature of a running tread of the wheel.

6. The system of claim 5, wherein a first one of the at least two matrix ultrasonic probes is configured to emit the inspection ultrasonic signal towards the inspection area, and a second one of the at least two matrix array ultrasonic probes is configured to measure the inspection ultrasonic signal reflected from a defect within the inspection area.

7. The system of claim 5, wherein a first one of the at least two matrix ultrasonic probes and a second one of the at least two ultrasonic probes are each configured to both emit the inspection ultrasonic signal towards the inspection area and to measure the inspection ultrasonic signal reflected from a defect within the inspection area.

8. The system of claim 1, wherein the probe positioning assembly is configured to reversibly lift the wheel above an underlying surface and to rotate the wheel while lifted.

9. The system of claim 2, further comprising an annunciator in communication with the analyzer and configured to annunciate a first annunciation representing validation of the inspection ultrasonic signal in response to receipt of the first notification and a second annunciation representing invalidation of the inspection ultrasonic signal in response to receipt of the second notification.

10. A method, comprising:
positioning one or more matrix array ultrasonic probes for ultrasonic communication with a wheel including at least one coupling validation geometry;
emitting, by each of the one or more matrix array ultrasonic probes, a validation ultrasonic signal directed towards a coupling validation geometry within the wheel;
measuring, by each of the one or more matrix array ultrasonic probes, its emitted validation ultrasonic signal after reflection from a respective one of the at least one coupling validation geometry;
emitting, by at least one of the matrix array ultrasonic probes, an ultrasonic inspection signal towards an inspection area of the wheel;
measuring, by at least one of the matrix array ultrasonic probes, the inspection ultrasonic signal after reflection from a defect positioned within the inspection area;
receiving, by an analyzer in communication with each of the one or more matrix array ultrasonic probes, the measured validation ultrasonic signal and the measured inspection ultrasonic signal;
determining, by the analyzer, that the measured validation ultrasonic signal matches a reference validation signal; and
outputting, by the analyzer, a first notification representing validation of the measured inspection ultrasonic signal.

11. The method of claim 10, further comprising, by the analyzer,
determining that the measured validation ultrasonic signal does not match the reference validation signal; and
outputting a second notification representing invalidation of the measured inspection ultrasonic signal.

12. The method of claim 10, wherein each of the matrix array ultrasonic probes is configured to sweep the emitted validation ultrasonic beam through an arc of predetermined directions and measure a plurality of validation ultrasonic signals after reflection from a plurality of respective coupling validation geometries.

13. The method of claim 10, wherein each of the matrix array ultrasonic probes emitting the inspection ultrasonic signal is configured to sweep the inspection ultrasonic signal through an arc of predetermined directions, and each of the matrix array ultrasonic probes measuring the reflected inspection ultrasonic beam is configured to measure a plurality of inspection ultrasonic signals after reflection from a plurality of respective defects within the inspection area.

14. The method of claim 10, wherein the at least one matrix array ultrasonic probe comprises at least two matrix array ultrasonic probes, and wherein the at least two matrix array ultrasonic probes are positioned with respect to one another in a configuration mimicking a curvature of a running tread of the wheel.

15. The method of claim 14. wherein a first one of the at least two matrix ultrasonic probes is configured to emit the inspection ultrasonic signal towards the inspection area, and a second one of the at least two matrix array ultrasonic probes is configured to measure the inspection ultrasonic signal reflected from a defect within the inspection area.

16. The method of claim 14, wherein a first one of the at least two matrix ultrasonic probes and a second one of the at least two ultrasonic probes are each configured to both emit the inspection ultrasonic signal towards the inspection area and to measure the inspection ultrasonic signal reflected from a defect within the inspection area.

17. The method of claim 10, wherein the one or more matrix array ultrasonic probes are positioned with respect to the wheel while the wheel is lifted above an underlying surface.

18. The method of claim 17, further comprising rotating the wheel while lifted and after each matrix array ultrasonic probe measures its emitted validation ultrasonic signal and emits and/or measures its inspection ultrasonic signal.

19. The method of claim 10, wherein the wheel is a train wheel.
